(19) United States
(12) Patent Application Publication
(10) Pub. No.: US 2017/0317709 A1
(43) Pub. Date: Nov. 2, 2017

(54) Information Handling System Antenna Sharing with Distributed Tuning Control

(71) Applicant: Dell Products L.P., Round Rock, TX (US)

(72) Inventors: Liam Prendergast, Limerick (IE); Gerald R. Pelissier, Mendham, NJ (US)

(73) Assignee: Dell Products L.P., Round Rock, TX (US)

(21) Appl. No.: 15/143,829

(22) Filed: May 2, 2016

(51) Int. Cl. H04B 1/401; H04B 7/0413; H04W 88/06; H04W 84/12

(52) U.S. Cl. CPC H04B 1/401; H04B 7/0413; H04W 88/06; H04W 84/12

(57) ABSTRACT

A portable information handling system having plural radios, each radio having a dedicated antenna and interfaced with a common shared antenna. A controller tunes the shared antenna to support a multi-antenna configuration of one of the radios, such as a MIMO configuration, based upon one or more predetermined conditions, such as data communication supported by the radios, signal strength associated with the radios, proximity sensing at the information handling system housing, and a rotational relationship of rotationally coupled housing portions.

### BACKGROUND OF THE INVENTION

### Field of the Invention

The present invention relates in general to the field of information handling system wireless communication, and more particularly to an information handling system antenna sharing with distributed tuning control.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Portable information handling systems continue to shrink in size and increase in capability. End users appreciate small portable systems that readily travel so that end users can access information on-the-go. End users tend to prefer smartphone or tablet information handling systems for accessing information that does not require extended input interactions. For example, end users access email and Internet resources through a touchscreen display that presents a keyboard to accept inputs. Touchscreen display keyboard interfaces provide a convenient input device where only minimal inputs are required, however, touchscreen display keyboard interfaces generally do not conveniently support more complex input tasks, such as word processing. Generally, end users who have to perform input intensive tasks while mobile will rely on portable information handling systems that integrate a keyboard, such as systems that have a convertible or clamshell configuration. For example, convertible and clamshell systems have a main housing portion that contains processing components and a lid housing portion that contains a display. The main and lid housing portions rotationally couple to each other with a hinge that supports the display in a viewing position relative to an integrated keyboard in an upper surface of the main portion. In convertible systems, the housing portions rotate 360 degrees relative to each other so that the display is exposed for use as a tablet.

Information handling system manufacturers face many challenges when designing and building portable information handling systems that have minimal size. Processing components are placed in portable housings to provide as much processing capability as possible in a confined space while minimizing power consumption and managing thermal constraints and including an integrated battery. Generally, portable information handling systems have one data port that accepts a cable to provide both data transfer and power transfer, such as Type C USB port. Instead of using cabled connections for peripherals, portable information handling system typically rely on wireless communication, such as Bluetooth or WiGig 60 GHz interfaces. Instead of using Ethernet connections for network communication, portable information handling systems typically rely on wireless network communication, such as IEEE 802.11 wireless local area networks (WLAN) and cellular network service provider wireless wide area networks (WWAN).

One difficulty with reliance on wireless communication is that antenna for sending and receiving wireless signals must be integrated in the portable housing and interfaced with the wireless radio. Poor antenna placement and design impacts wireless communication reliability and data rates, resulting in a poor end user experience. Portable information handling systems tend to have limited options for placement of antenna both because of the minimal housing footprint and the number of components integrated in the housing. In order to enhance antenna efficiency, some portable information handling systems integrate arrays of 2×2 or 3×3 antenna that support multiple input multiple output (MIMO) antenna configurations. Although MIMO configurations enhance wireless antenna efficiency, integrating multiple antenna in limited space presents design and layout difficulties.

### SUMMARY OF THE INVENTION

Therefore, a need has arisen for a system and method which provides an information handling system antenna sharing with distributed tuning control.

In accordance with the present invention, a system and method are provided which substantially reduce the disadvantages and problems associated with previous methods and systems for supporting wireless communication at a portable information handling system. First and second radios having first and second dedicated antenna selectively interface with a shared antenna to provide improved wireless communication efficiency, such as with a MIMO antenna configuration.

More specifically, a portable information handling system processes information with processing components disposed in portable housing, such as a housing having rotationally coupled housing portions. Plural radios disposed in the housing wirelessly communicate the information with externals radios, such as through WLAN, WWAN, Bluetooth and similar wireless protocols. For example, a WWAN radio communicates information through a dedicated antenna that resonates in the WWAN radio frequency band, and a WLAN radio communicates information through a dedicated antenna that resonates in the WLAN radio frequency band, such as 2.4 GHz and 5 GHz. A shared antenna selectively supports wireless communication with one of the WWAN or WLAN radio based upon one or more predetermined conditions. For example, an embedded controller separate from the WWAN and WLAN radios selectively interfaces the shared antenna with one of the WWAN or WLAN radios by tuning the shared antenna to resonate at the radio frequency of the selected radio. In one embodiment, the selected radio then has a multiple antenna configuration to support MIMO wireless signaling while the unselected radio has a single or dual dedicated antenna to support wireless signaling in a single antenna or dual antenna configuration. The predetermined conditions managed by the embedded controller include the amount of data handled by each radio, the relative signal strength of each radio, objects sensed by a proximity sensor of the information handling system, and a relative rotational relationship of the information handling system housing portions.

The present invention provides a number of important technical advantages. One example of an important technical advantage is that MIMO antenna configurations are supported to communicate wireless signals at a portable information handling system with a shared antenna that reduces the amount of space used by the antenna structure. Management of tuning of the shared antenna by a controller external to the radios provides dynamic adaption of the antenna configuration based upon conditions detected at the information handling system, such as the amount of data communicated by each radio or physical conditions that impact antenna performance, like object proximity or housing configuration. Improved antenna performance with dynamic assignment of a MIMO configuration provides an enhanced user experience with more rapid power transfers and reduced radio power consumption contained in a housing having a reduced physical footprint.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts portable information handling systems interfaced with multiple wireless networks;

FIG. 2 depicts a circuit block diagram of a portable information handling system having wireless communication through multiple radios supported by a shared antenna; and

FIG. 3 depicts a flow diagram of a process for configuring a shared antenna to communicate with multiple radios.

### DETAILED DESCRIPTION

A portable information handling system dynamically shares an antenna between plural radios to selectively configure MIMO wireless communication based upon one or more operating conditions detected at the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

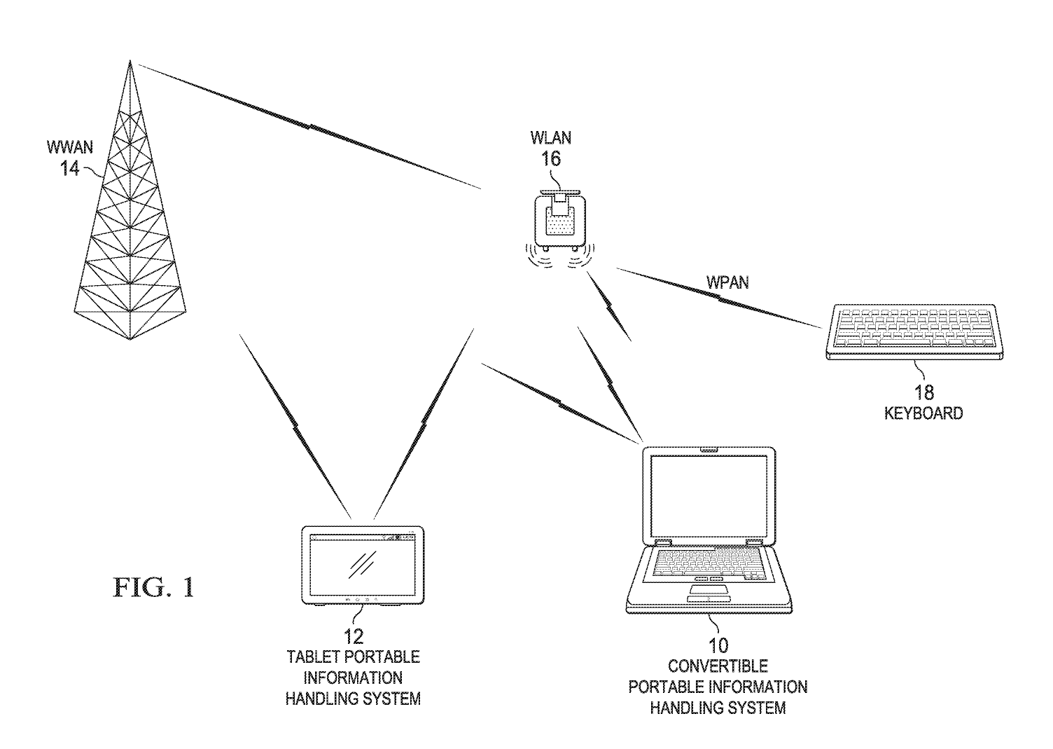

Referring now to FIG. 1, portable information handling systems 10 and 12 are depicted interfaced with multiple wireless networks. In the example embodiment, portable information handling system 10 has a convertible configuration having lid and main housing portions rotationally coupled to each other. In the depicted clamshell configuration, the end user has access to an integrated keyboard with a display raised in a viewing position. The rotationally coupled housing portions rotate between a closed position having the display closed over top of the keyboard and a tablet position having the display rotated 360 to conveniently present a tablet interface. Portable information handling system 12 has a tablet configuration built into a planar housing. An end user interacts with the display touchscreen, such as through a presented keyboard image, to make typed inputs. Information handling systems 10 and 12 provide two examples of physical housing configurations, however, in alternative embodiments alternative types of information handling systems may include the shared antenna architecture described herein.

In the example embodiment, portable information handling systems 10 and 12 interface with a wireless wide area network (WWAN) 14 and/or a wireless local area network (WLAN) 16 to communicate networked information, such as through the Internet or an intranet. WWAN 14 is provided by cellular network service providers to support wireless voice and data transfer into the phone networks and Internet. Typical WWAN radio frequencies vary based upon the licensed frequency band of the cellular network provider and the available channels within a network at the time a wireless interface is established. Some examples of frequency bands found in conventional networks include 800-850 MHz, 1700-2100 MHz, and 2300-2700 MHz, although a number of other frequency bands are used. The frequency that a particular WWAN communication uses is typically managed by the WWAN service provider and programmatically set within information handling system radios based upon WWAN service provider and standardized protocols, such as LTE or GSM protocols. In contrast, WLAN communications take placed through unlicensed radio bands, such as 2.4 GHz, 5 GHz and 60 GHz. Information handling systems interface through access points operating in the WLAN frequency band using available channels and IEEE 802.11 standardized protocols to deconflict radio transmissions from other sources operating in the frequency band. An advantage of WLAN hotspots is that a number of public and enterprise access points provide free Internet interfaces with rapid data transfer rates. In contrast, WWAN interfaces typically have a fee and offer lower data transfer rates, however, WWAN interfaces carry over longer distances and with more guaranteed access, such as those found with cell phone communications.

In the example embodiment, portable information handling systems 10 also communicate with peripheral devices through a wireless personal area network (WPAN), such as Bluetooth. For example, a keyboard 18 accepts end user typed inputs and sends the typed inputs to portable information handling systems 10 or 12 as wireless signals. Other types of peripherals that wirelessly communicate with an information handling system include mice, printers, displays, etc. Peripheral devices communicate at low or high data rates and may use WLAN interfaces through an access point or an ad hoc network connection.

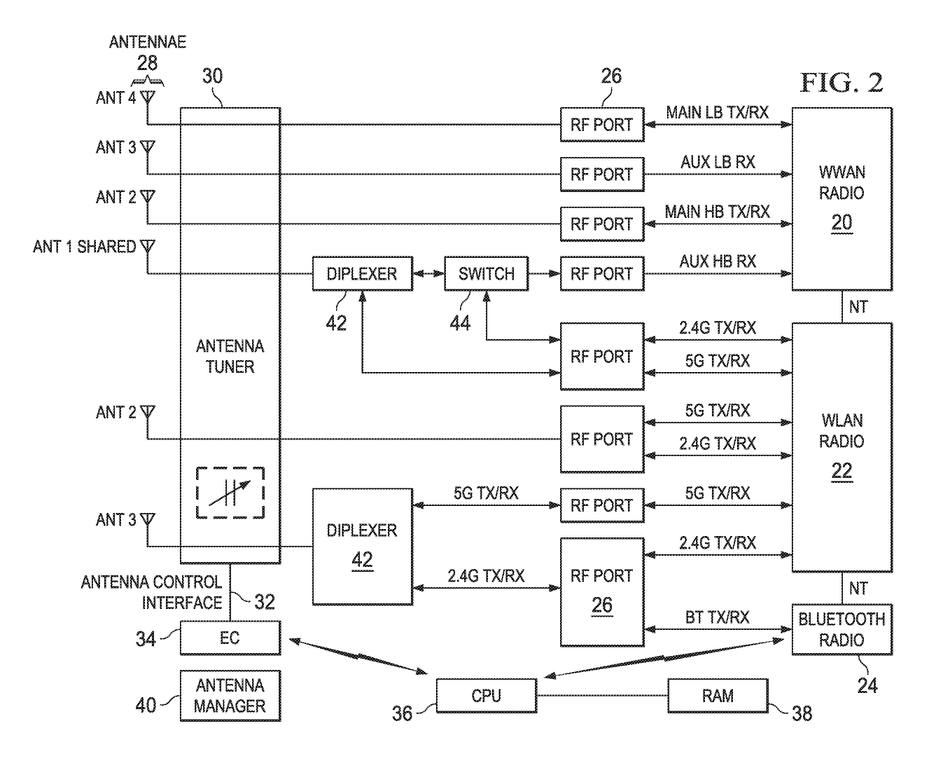

Referring now to FIG. 2, a circuit block diagram depicts a portable information handling system having wireless communication through multiple radios supported by a shared antenna. In the example embodiment, a WWAN radio 20, a WLAN radio 22 and a Bluetooth radio 24 each interface through RF ports 26 to exchange wireless signals through antennae 28. Each radio 20, 22 and 24 includes access through RF ports 26 with a tuner 30 that adjusts the antenna 28 tuning to match the frequency of the wireless signal used by the radio. In the example embodiment, WWAN radio 20 communicates through a low frequency band with first and second antenna 28 (ANT 4 and ANT 3) and a high frequency band with first and second antenna 28 (ANT 2 and ANT 1). In each frequency band, the availability of two antenna 28 provides improved wireless signal transmission and reception by setting up a MIMO antenna configuration. WLAN radio 22 communicates through 2.4 GHz and 5 GHz frequency bands with first, second and third antenna 28 (ANT 1, ANT 2 and ANT 3). By using all three antenna. WLAN radio 22 has improved wireless signal transmission and reception through a 3×3 MIMO configuration. Bluetooth radio 24 communicates through a 2.4 GHz frequency band with a single antenna 28 (ANT 3) shared with WLAN radio 22, as described in further detail below. In one operational mode, antenna tuner 30 tunes antennae 28 in response to setting communicated from radios 20, 22 and 24. Radio-based tuning is adequate where an antenna is dedicated to a radio, such as is the case with ANT 2, 3 and 4. In the example embodiment, one antenna (ANT 1) is shared by WWAN radio 20 and WLAN radio 22 so that entirely different antenna tuning may be required at ANT 1 depending upon which radio is active.

In the example embodiment, a host-based distributed antenna tuning and control architecture promotes effective sharing of one or more antenna 28 between plural radios operating at plural frequencies. An embedded controller 34, such as a keyboard controller running BIOS code, controls antenna tuning through an antenna control interface 32, such as an SPI link. For example, embedded controller 34 receives radio configuration information from an operating system running on a central processing unit (CPU) 36 and random access memory (RAM) 38, and applies the radio configuration information with an antenna manager 40 executing as embedded code. Antenna manager 40 tunes antenna 28 to support wireless communication in the frequency appropriate to the radio 20, 22 or 24 that interfaces with each antenna 28. For example, antenna manager 40 overrides antenna tuning from the individual radios to provide a host-system managed antenna configuration. Antenna manager 40 in the example embodiment directly controls antenna tuning performed by tuner 30, however, in alternative embodiments, antenna manager 40 directs each radio to perform or not perform antenna tuning at a shared antenna based upon the priority for the system regarding which radio should have access to the shared antenna.

In the example embodiment, antenna manager 40 selects one of WWAN radio 20 or WLAN radio 22 to have priority for communicating with shared antenna 28 ANT 1 based upon one or more factors. As an example, antenna manager 40 configures WWAN radio 20 high band communications to use a MIMO antenna configuration if an active data transfer is taking place through the high band frequency. In such as mode, a 2×2 MIMO configuration is supported at both WWAN radio 20 and WLAN radio 22. In the event that WWAN radio 20 is not active, antenna manger 40 configures WWAN radio to communicate with a single antenna configuration while WLAN radio 22 communicates with a 3×3 MIMO configuration. If both WWAN radio 20 and WLAN radio 22 are active, antenna manager 40 selectively enables MIMO antenna configuration at WWAN radio 20 based upon the relative amount of data transfer supported by each radio or the radio signal strength of each radio, such as measured by return signal strength indications (RSSI) or bit rate error (BRE). Other factors may drive antenna configuration, such as the relative rotational configuration of housing portions or the sensing of an object in the proximity of one or more antenna. For example, a closed housing may indicate a traveling system that will rely on WWAN communications to receive notifications, while an open housing configuration may indicate an established work environment likely to have WLAN presence. Although the example embodiment shows a single shared antenna between the WWAN high band (such as 2.3 to 2.7 GHz band) and the WLAN band, the host-centered control interface for antenna tuning can be applied to other dedicated and share antenna 28 or limited to just the shared antenna or a subset of shared antenna ports 26. In various embodiments, multi-tuning can be effected to simultaneously tune multiple antenna ports with the same set of tuning adjustments (symmetric) or with different tuning adjustments for each port (asymmetric). The host-based tuning solution enables a reduction in the size of an antenna structure by sharing one or more antenna with plural radios, such as in the example embodiment where 3×3 WiFi, Bluetooth and LTE WWAN are supported.

In the example embodiment of FIG. 2, four radio frequency feed lines proceed from WWAN radio 20, a main low band, a main high band, an auxiliary low band, and an auxiliary high band. WWAN radio 20 high band auxiliary signals are routed through a diplexer 42 and switch 44. Diplexer 42 includes a 5 GHz band filter port that routes to a 5 GHz input of WLAN radio 22 and a 2.4 GHz filter port that routes to switch 44. Switch 44 includes one 2.3-2.7 GHz port that routes to WWAN radio 20 and a 2.4 GHz port that routes to the 2.4 GHz input of WLAN radio 22. Diplexer 42 and switch 44 enable concurrent operation of WLAN 5 GHz and LTE bands since filtering is provided; LTE and WLAN 2.4 GHz support is managed by commands provided from antenna manger 40, which tunes antenna 28 ANT 1 for the active radio and commands WWAN radio 20 and WLAN radio 22 to turn on and off communications at ports 26 as appropriate. WLAN radio 22 has a single feed from a dedicated antenna 28 (ANT 2), a shared antenna 28 with WWAN radio 20 (ANT 1) and a shared antenna 28 with Bluetooth radio 24 (ANT 3). Sharing between WLAN radio 22 and Bluetooth radio 24 is supported by a diplexer 42 that coordinates and filters communication between 2.4 and 5 GHz feeds. WWAN radio 20 uses a dual feed for antenna ports 26 to enable a balanced antenna design between main and auxiliary radio feeds and also enables dual tuning for the WWAN low band and high band for best LTE performance. Under the management of antenna manager 40, WWAN radio 20 and WLAN radio 22 selectively communicate through a shared antenna structure to support single, multiple and MIMO antenna configurations based on system communication needs.

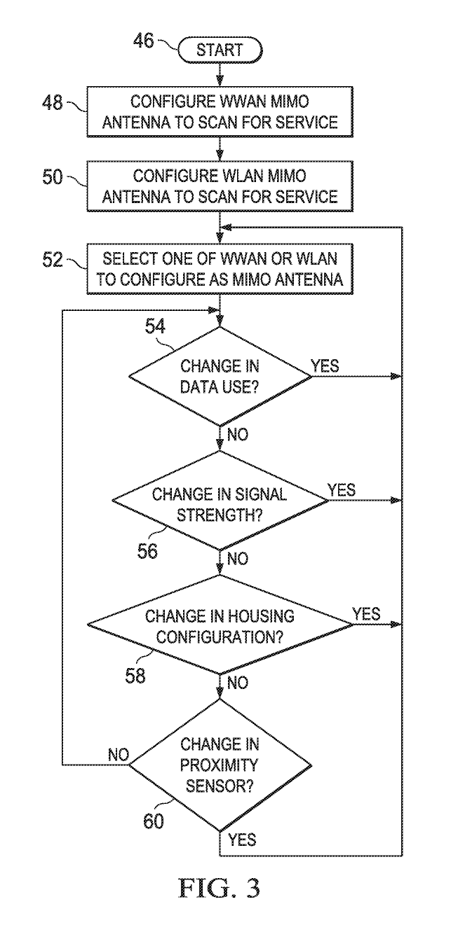

Referring now to FIG. 3, a flow diagram depicts a process for configuring a shared antenna to communicate with multiple radios. The process starts at step 46 with power on of the information handling system radio. At step 48, the WWAN radio is configured with a dual antenna configuration to scan for WWAN service. Once available services and signal strengths are determined, the process continues to step 50 to configure the WLAN radio for MIMO antenna configuration with the shared antenna to scan for available WLAN services. After available services are determined, at step 52 one of the WWAN or WLAN radio is assigned the shared antenna to establish a network interface. The assignment may be based upon any of the factors describe above, such as signal strength, data needs, housing configuration, etc. Once an antenna configuration for the shared antenna is established, monitoring of radio and antenna operations is performed to adapt antenna configuration as needed by changing information handling system operations. At step 54, a determination is made of whether a change in data use has occurred at the radios that share the antenna. If so, the process returns to step 52 to select the radio with which the antenna should be configured. If not, the process continues to step 56 to determine if a change in signal strength has occurred. If so, the process returns to step 52 to determine if reallocation of the shared antenna will offer improved communication, such as by improving signal strength at the weak radio or moving communications and the shared antenna assignment to the radio have acceptable signal strength. At step 58, a determination is made of whether a housing configuration change has occurred, such as might be indicated by an accelerometer input or sensors that determine relative housing position. If a change in housing configuration has occurred, the process returns to step 52 to determine an appropriate antenna and radio configuration. At step 60, a determination is made of whether a change in proximity sensing has detected an object at one or more of the plural antenna. If so, the process returns to step 52 to determine an appropriate antenna and radio configuration. If not, the process returns to step 54 to continue monitoring of the antenna and radio configuration conditions.

Although the present invention has been described in detail, it should be understood that various changes, substitutions and alterations can be made hereto without departing from the spirit and scope of the invention as defined by the appended claims.

1. A portable information handling system comprising:
a housing;
a processor disposed in the housing and operable to execute instructions to process information;
a memory disposed in the housing and interfaced with the processor, the memory operable to store the information;
plural radios interfaced with the processor and operable to transmits and receive wireless signals;
a first antenna interfaced only with a first of the plural radios to support wireless signal transmission and reception by the first of the plural radios;
a second antenna interfaced with only a second of the plural radios to support wireless signal transmission and reception by the second of the plural radios;
a third antenna selectively interfaced with one of the first or second of the plural radios, the third antenna supporting wireless signal transmission and reception by the one of the first or second radios to which the third antenna is selectively interfaced; and
an embedded controller separate from the plural radios and operable to selectively interface the third antenna with one of the first or second radios based upon one or more predetermined conditions.

2. The portable information handling system of claim 1 wherein the one or more predetermined conditions comprises an amount of data communication supported by the first and second radios, the embedded controller configuring the selected one of the first and second radios to interface with the third antenna in a MIMO configuration and the other of the first and second radios to communicate with a single antenna.

3. The portable information handling system of claim 1 wherein the one or more predetermined conditions comprise an orientation of the housing.

4. The portable information handling system of claim 1 further comprising an antenna tuning circuit interfaced with the third antenna, wherein the embedded controller commands tuning of the third antenna to match a radio frequency of the selected of the first and second radios interfaced with the third antenna.

5. The portable information handling system of claim 1 wherein the first of the plural radios comprises a wireless wide area network (WWAN) radio having a low band portion coupled to third and fourth antenna and a high band portion coupled to a dedicated fifth antenna and selectively coupled to the third antenna.

6. The portable information handling system of claim 5 wherein the second of the plural radios comprises a wireless local area network (WLAN) radio coupled to a dedicated sixth antenna and selectively coupled the third antenna.

7. The portable information handling system of claim 6 wherein the WWAN high band comprises communication in the 2.3 GHz to 2.7 GHz radio band.

8. The portable information handling system of claim 7 further comprising a switch disposed between the third antenna and the WWAN and WLAN radios.

9. A method for communicating wireless signals at a portable information handling system, the method comprising:
coupling a first radio to a first dedicated antenna;
coupling a second radio to a second dedicated antenna; and
selecting one of the first or second radios to interface with a third antenna based upon one or more predetermined conditions; and
communicating wireless signals with the selected radio and third antenna.

10. The method of claim 9 further comprising:
determining at a controller separate from the selected radio a radio frequency at which the third antenna communicates; and
in response to determining, commanding tuning of the third antenna with the controller.

11. The method of claim 10 further comprising:
determining at the unselected radio that the third antenna is not interfaced with the unselected radio; and
in response to determining at the unselected radio, communicating wireless signals in a single-antenna configuration.

12. The method of claim 9 wherein the predetermined condition comprises the amount of data communication associated with each of the first and second radios.

13. The method of claim 9 wherein the predetermined condition comprises a signal strength associated with each of the first and second radios.

14. The method of claim 9 wherein the predetermined condition comprises a rotational position of rotationally-coupled housing portions relative to each other.

15. A portable information handling system radio system comprising:
a WWAN transceiver having a dedicated antenna;
a WLAN transceiver having a dedicated antenna;
a shared antenna interfaced with the WWAN transceiver and the WLAN transceiver;
a tuning circuit interfaced with the shared antenna and operable to tune the resonance of the shared antenna; and
a controller interfaced with the tuning circuit and operable to selectively tune the shared antenna based upon one or more predetermined conditions to one of a resonance for the WWAN transceiver or the WLAN antenna.

16. The portable information handling system radio system of claim 15 wherein the controller selectively tunes the shared antenna to resonance for the WWAN antenna, and the WWAN radio communicates with a MIMO configuration.

17. The portable information handling system radio system of claim 16 wherein the WLAN radio communicates with a dual antenna configuration.

18. The portable information handling system radio system of claim 16 wherein the predetermined condition comprises a return signal strength indicator associated with the WWAN radio of less than a predetermined amount.

19. The portable information handling system radio system of claim 16 wherein the predetermined condition comprises a return signal strength indicator associated with the WLAN radio of greater than a predetermined amount.

20. The portable information handling system radio system of claim 15 wherein the predetermined condition comprises a proximity sensor detection of an object proximate to one or more of the dedicated and shared antenna.
